(19) United States
(12) Patent Application Publication
(10) Pub. No.: US 2026/0080661 A1
(43) Pub. Date: Mar. 19, 2026

(54) EFFICIENT ON-DEVICE PET CLUSTERING USING FACE AND BODY FEATURES

(71) Applicant: SAMSUNG ELECTRONICS CO., LTD., Suwon-si (KR)

(72) Inventors: Ning Ye, Toronto (CA); Zhiming Hu, Maple (CA); James Alan Gleeson, Toronto (CA); Ke Zhao, Toronto (CA); Richard Wildes, Toronto (CA); Iqbal Ismail Mohomed, Markham (CA); Sven Josef Dickinson, Toronto (CA)

(73) Assignee: SAMSUNG ELECTRONICS CO., LTD., Suwon-si (KR)

(21) Appl. No.: 19/254,632

(22) Filed: Jun. 30, 2025

Related U.S. Application Data
(60) Provisional application No. 63/694,542, filed on Sep. 13, 2024.

(51) Int. Cl. G06V 10/762; G06V 10/40; G06V 10/74; G06V 20/30; G06V 40/10

(52) U.S. Cl. CPC G06V 10/762; G06V 10/40; G06V 10/761; G06V 20/30; G06V 40/10

(57) ABSTRACT

A method performed by at least one processor includes receiving a plurality of images; detecting an object in at least one image from the plurality of images; performing feature extraction on the object to extract a first feature of the object and extract a second feature of the object; selecting an image from the plurality of images; based on determining the selected image includes the first feature, adding the selected image to a cluster associated with the object; and based on determining the selected image does not include the first feature and includes the second feature, adding the selected image to the cluster associated with the object based on determining that the second feature satisfies a feature distance condition.

### CROSS-REFERENCE TO RELATED APPLICATION

This application claims the benefit of U.S. provisional application No. 63/694,542 filed on Sep. 13, 2024, the entire contents of which are incorporated herein by reference.

### BACKGROUND

### 1. Field

This disclosure is directed to utilizing face and body features for clustering and processing images.

### 2. Related Art

With growing pet ownership comes continuously growing galleries of pet photos, necessitating the need for on-device pet clustering software systems that enable tagging and subsequent retrieval of user pet photos. Such a system should automatically group images of the same pet into one cluster, after which the user can easily assign cluster-level labels to associate all images within a cluster to some identity.

However, designing a pet clustering system is particularly challenging due to the need for high precision (e.g., images in a cluster refer to the same identity) and recall (e.g., images of an identity are grouped in the same cluster) under diverse conditions, including variations in illumination, expressions, viewpoints and occlusions. Furthermore, practical deployments must scale to continuously growing galleries of photos and operate entirely on-device to respect user privacy and wireless connectivity constraints.

Existing approaches share limitations that hinder practical deployment to today's user galleries. Most tools only use face appearance features to achieve high precision for pet recognition/identification, but ignore images where only pet bodies are visible, which frequently occur in real user galleries. Moreover, these tools often cluster the images in batch mode instead of an incremental mode where images are gradually added to a user's gallery. Notably, these approaches typically rely on cloud-based infrastructure without considering the privacy, connectivity, and runtime constraints of mobile user galleries.

### SUMMARY

According to an aspect of the disclosure, a method performed by at least one processor includes receiving a plurality of images; detecting an object in at least one image from the plurality of images; performing feature extraction on the object to extract a first feature of the object and extract a second feature of the object; selecting an image from the plurality of images; based on determining the selected image includes the first feature, adding the selected image to a cluster associated with the object; and based on determining the selected image does not include the first feature and includes the second feature, adding the selected image to the cluster associated with the object based on determining the second feature satisfies a feature distance threshold.

According to an aspect of the disclosure, an apparatus includes a memory; processing circuitry coupled to the memory, the processing circuitry configured to: receiving a plurality of images, detecting an object in at least one image from the plurality of images, performing feature extraction on the object to extract a first feature of the object and extract a second feature of the object, selecting an image from the plurality of images, based on determining the selected image includes the first feature, adding the selected image to a cluster associated with the object, and based on determining the selected image does not include the first feature and includes the second feature, adding the selected image to the cluster associated with the object based on determining the second feature satisfies a feature distance threshold.

According to an aspect of the disclosure, a non-transitory computer readable medium having in instructions stored therein, which when executed by a processor cause the processor to execute a method including: receiving a plurality of images; detecting an object in at least one image from the plurality of images; performing feature extraction on the object to extract a first feature of the object and extract a second feature of the object; selecting an image from the plurality of images; based on determining the selected image includes the first feature, adding the selected image to a cluster associated with the object; and based on determining the selected image does not include the first feature and includes the second feature, adding the selected image to the cluster associated with the object based on determining the second feature satisfies a feature distance threshold.

### BRIEF DESCRIPTION OF DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, in accordance with embodiments of the present disclosure.

FIG. 2 is a block diagram of example components of one or more devices of FIG. 1, in accordance with embodiments of the present disclosure.

FIG. 3 illustrates an example of how image clusters are created from a gallery of images, in accordance with embodiments of the present disclosure.

FIG. 4 illustrates an overview of an example clustering system pipeline, in accordance with embodiments of the present disclosure.

FIG. 5 illustrates an example image clustering pipeline, in accordance with embodiments of the present disclosure.

FIG. 6 illustrates a flowchart of a process for clustering images, in accordance with embodiments of the present disclosure.

FIG. 7 illustrates a flowchart of a process for clustering images using body features, in accordance with embodiments of the present disclosure.

FIG. 8 illustrates a flowchart of a process for determining when to relax a visual similarity threshold, in accordance with embodiments of the present disclosure.

FIG. 9 illustrates an example block diagram of the clustering system, in accordance with embodiments of the present disclosure.

FIG. 10 illustrates an example pet detection and feature extraction system, in accordance with embodiments of the present disclosure.

FIG. 11 illustrates a flowchart of a face clustering process, in accordance with embodiments of the present disclosure.

FIG. 12 illustrates an example of a C-Clustering operation, in accordance with embodiments of the present disclosure.

FIG. 13 illustrates a flowchart of a body clustering process, in accordance with embodiments of the present disclosure.

FIG. 14 illustrates a flowchart of an example metadata clustering process, in accordance with embodiments of the present disclosure.

FIG. 15 illustrates example visual similarity and metadata similarity data conditions, in accordance with embodiments of the present disclosure.

FIG. 16 illustrates a flowchart of an example delayed clustering process, in accordance with embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware or firmware. The actual specialized control hardware used to implement these systems and/or methods is not limiting of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

The embodiments are directed to an efficient on-device incremental image clustering system (e.g., pet clustering system) to group images (e.g. pet images) into different clusters based on their identities. The embodiments simultaneously provide both high precision and high recall while running entirely on-device on large real-world user galleries.

The embodiments include a Face+Body clustering pipeline that clusters face-visible images first to form high precision clusters, followed by body-only images to improve clustering recall. Existing clustering tools only use face appearance features, but ignore images where only pet bodies are visible.

The embodiments include a visual clustering pipeline that is augmented to incorporate timestamp and GPS metadata to better capture contextual information for pet clustering. For example, for each pet image, it is checked whether the image meets the visual similarity and metadata similarity checks with the face clusters. If both checks are met, the distance requirement may be relaxed, and the image is further checked to determine whether the image is within the relaxed threshold of a cluster's centroid.

The embodiments include a clustering pipeline that is adapted to an incremental setting where images are gradually added to a gallery. Existing tools cluster the image in a batch mode and typically rely on cloud-based infrastructure without considering the privacy, connectivity, and runtime constraints of mobile user galleries. To improve clustering recall, a delayed clustering mechanism may be implemented to continuously re-cluster images that failed to be previously clustered. The embodiments can handle continuously growing galleries and scale independently of the gallery size, which is a requirement for enabling practical on-device deployments.

In the incremental setting, the need to make decisions based on the clustering results of previous days can potentially lead to cluster error accumulation. To mitigate this error, high precision face clusters may be used for classifying body-only images or cluster merging. Therefore, the embodiments are optimized for high precision in the initial face clusters at the expense of high recall, since recall will be achieved in subsequent clustering stages that incorporate body features and metadata.

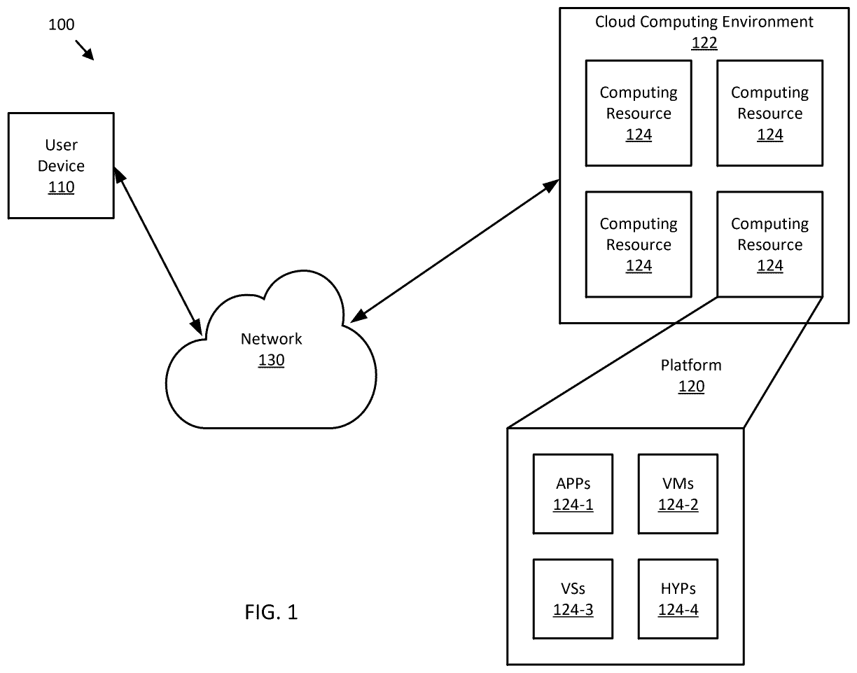

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSs) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

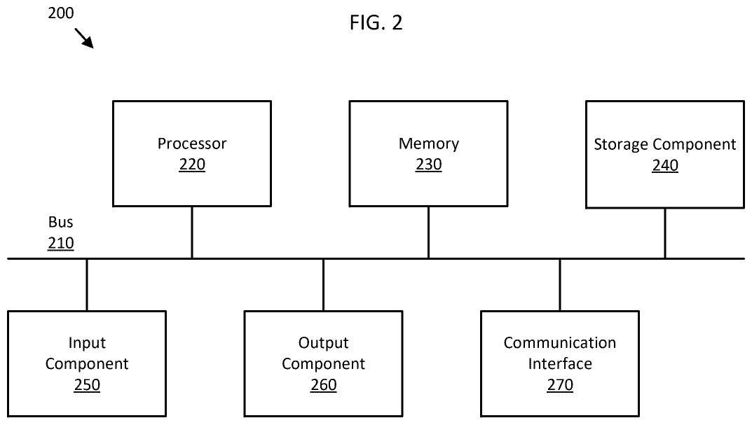

FIG. 2 is a block diagram of example components of one or more devices of FIG. 1. The device 200 may correspond to the user device 110 and/or the platform 120. The device 200 may be any other suitable device such as a TV, wall panel, etc. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

In one or more examples, the device 200 may be a controller of a smart home system that communicates with one or more sensors, cameras, smart home appliances, and/or autonomous robots. The device 200 may communicated with the cloud computing environment 122 to offload one or more tasks.

The embodiments are directed to an efficient incremental clustering solution configured to run on a device (e.g., smartphone, tablet, laptop, etc.) while maintaining both high recall and high precision. To achieve these advantageous features, images with visible faces are initially clustered to produce a preliminary set of clusters with high precision. Subsequently, recall is improved in two key ways: (1) for images without visible faces (e.g., body-only images), body features are used to merge them into existing face clusters, and (2) images within a similar time window of existing clusters are merged with a relaxed visual similarity threshold. Finally, to enable efficient on-device clustering, incremental clustering algorithms that scale independent of continuously growing sizes are used.

The embodiments of the present disclosure are described with respect to pet/animal images. However, as understood by one of ordinary skill in the art, the embodiments are not limited to pet/animal images, and may be applied to any gallery of images with objects having multiple distinctive features.

In one or more examples, the clustering system may first cluster frontal face images, and then use body features to cluster remaining images into existing face clusters to achieve both high precision and high recall. Second, the clustering system may leverage photo timestamp and GPS metadata to further boost recall and complement visual features. Third, the clustering system may implement a delayed clustering mechanism to re-cluster images that failed to get clustered previously to further improve recall.

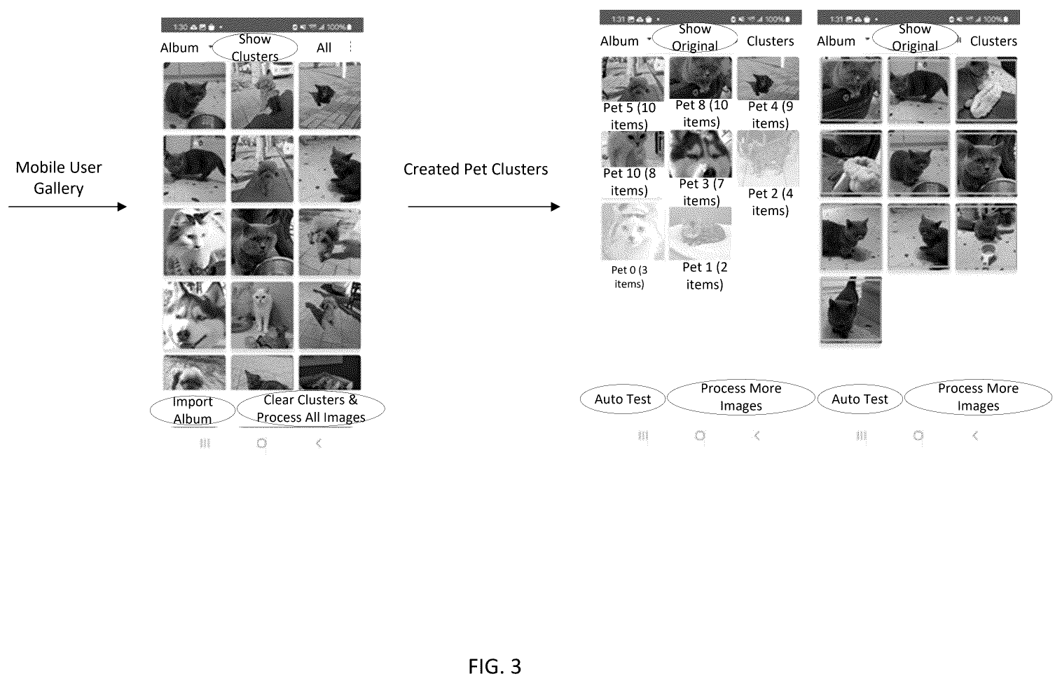

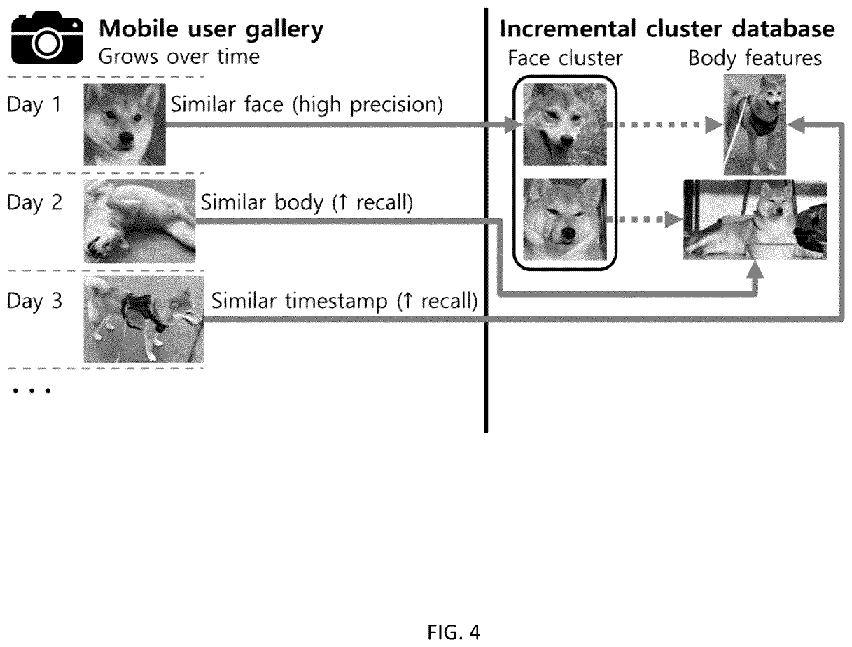

FIG. 3 illustrates an example of how image clusters are created from a gallery of images. The gallery of images may be located on a mobile device such as a smartphone, tablet, or laptop. FIG. 4 illustrates an overview of an example clustering system pipeline that may implement an on-device incremental pet clustering pipeline. As illustrated in FIG. 4, in one or more examples, on day 1, frontal face images may be clustered, on day 2, images may be clustered based on body features, and on day 3, images may be clustered using metadata and GPS. Accordingly, new pet images are efficiently and incrementally clustered on device. By leveraging face features, body features, and time metadata, the clustering system advantageously adapts to the growing number of photos, ensuring both high precision and recall in clustering results.

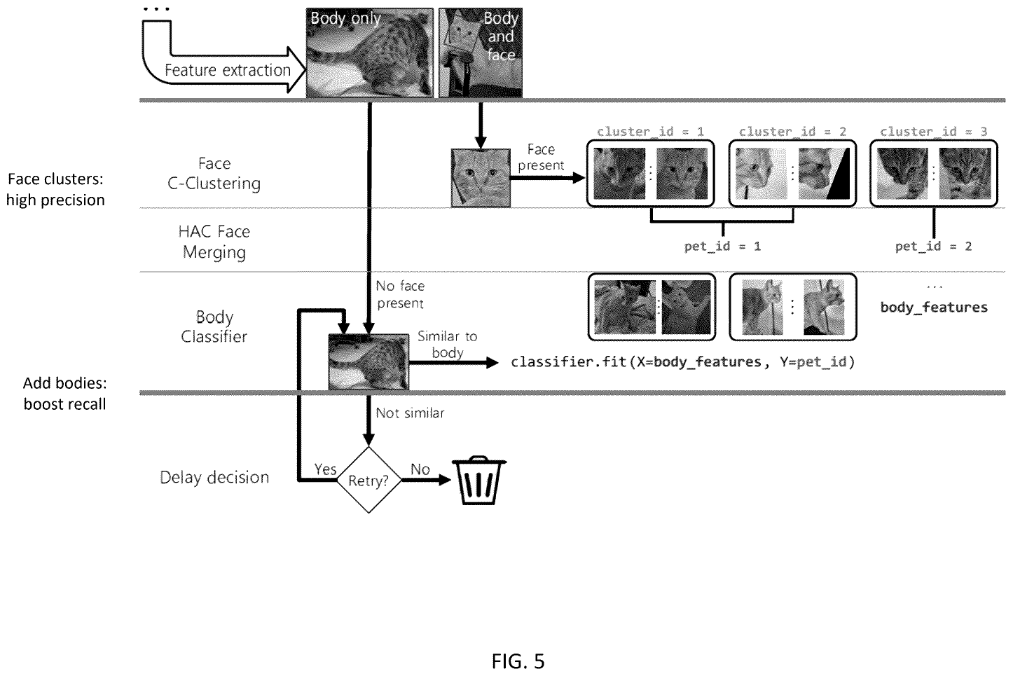

FIG. 5 illustrates an example image clustering pipeline. In one or more examples, the clustering system supports incremental clustering (e.g., add day-to-day images into pre-existing clusters). Given a set of images, face embeddings may be extracted for face-visible images and body embeddings for all pet images. The face embeddings may be processed by the Face C-Clustering and hierarchical agglomerative clustering (HAC) Face Merging stages to output compact, high precision face clusters. The C-Clustering algorithm is covered in further detail below. The Body Classifier may integrate body-only images and singleton clusters into existing face clusters. In one or more examples, a singleton cluster may refer to a cluster of size 1. When singleton clusters are formed in the face clustering stage, the singleton cluster may be for face-visible images only. In the incremental mode, a delayed clustering mechanism is introduced to re-cluster images that failed to get clustered in the current round by clustering them in subsequent rounds.

In one or more examples, the clustering pipeline illustrated in FIG. 5 may employ a divide-and-conquer approach, leveraging the distinctiveness of face appearances to cluster face-visible images first, followed by body-only images. To achieve this goal, face embeddings may be extracted for face-visible images and body embeddings for all the pet images. Next, the face-visible images may be clustered with the C-Clustering algorithm to form the initial clusters and apply hierarchical agglomerative clustering (HAC) to alleviate over-clustering. To improve clustering recall, body-only images may be added to existing clusters. These additions may be accomplished by fitting a classifier. The same classifier may be used to reduce singleton clusters.

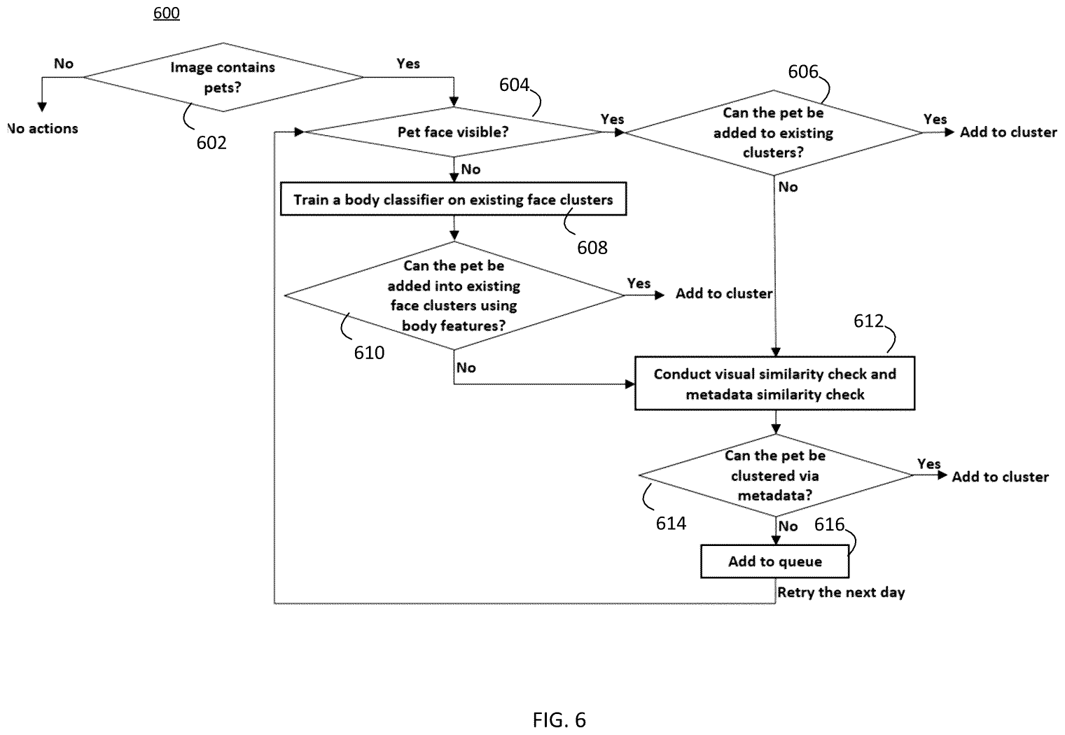

FIG. 6 illustrates an embodiment of a process 600 for performing image clustering. The process may start at operation 602 where it is determined if a gallery of image contains a particular object such as pets. If the gallery does not contain images of pets, no action is taken (e.g., no clusters formed or no images added to existing cluster). If the gallery does contain image of pets, the process proceeds to operation 604, where it is determined if a pet face is visible. If it is determined that the pet face is visible, the process proceeds to operation 606, and if it is determined that the pet face is not visible, the process proceeds to operation 608.

At operation 606, it is determined if an image containing a pet may be added to an existing cluster. If it is determined that an image of the pet may be added to the cluster, the image is added to the cluster. If it is determined that the image of the pet cannot be added to the cluster, the process proceeds to operation 612.

At operation 608, a body classifier is trained on existing face clusters. The process proceeds to operation 610, where it is determined if an image of a pet can be added into existing clusters using body features. If it is determined that an image of a pet can be added to an existing cluster using body features, the image is added to the existing cluster. If it is determined that the image of the pet cannot be added to the existing cluster using body features, the process proceeds to operation 612.

At operation 612, a visual similarity check and a metadata similarity check are performed. The process proceeds to operation 614, where it is determined if an image of a pet can be added to an existing cluster based on the metadata. If it is determined that the image of the pet can be added to the existing cluster, the image is added to the cluster. If it is determined that the image of the pet cannot be added to the existing cluster, the process proceeds to operation 616, where the image is added to a queue. The process returns from 616 to operation 604, where the procedures discussed above for operation 604 are repeated.

In one or more examples, the clustering system can cluster pet images with visible pet faces and images without visible pet faces. To cluster body-only images, embodiments may use a method that bootstraps from existing high precision face clusters. Embodiments may leverage the initial set of face clusters to create a training set for the body classifier, which is used to predict the cluster label for the body-only images, thereby maintaining high precision while boosting recall. The body classifier can be sparse coding (Eq. (2), see below) or k-nearest neighbor. These algorithms do not need to be trained with neural network gradient descent-based training, which is efficient at inference time.

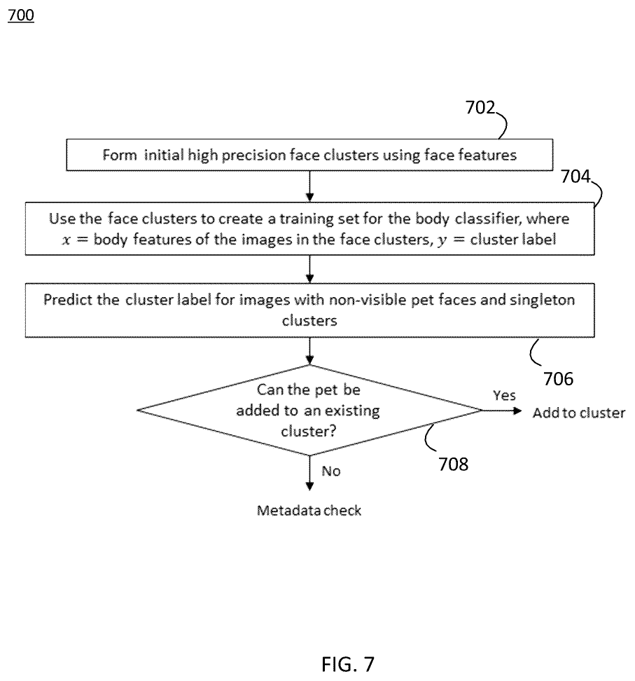

FIG. 7 illustrates a process 700 of an embodiment of performing clustering using body features. The process may start at operation 702 where initial high precision face clusters are formed using face features. The process proceeds to operation 704 where the face clusters are used to create a training set for the body classifier, where X equals body features of the images in the face clusters, and Y equals a cluster label. The parameters X and Y may be used in the generic classifier equation (classifier.fit(X=body_features, Y=pet_id)) in FIG. 5.

The process proceeds to operation 706, where the cluster label for images with non-visible pet faces and singleton clusters are predicted. The process proceeds to 708, where it is determined whether to add an image to the existing cluster. If the image can be added to the existing cluster (e.g., image contains body features that are close to the ones in existing clusters), the image is added to the existing cluster. For example, if the body feature satisfies a feature distance condition (e.g., body feature is similar to existing clusters), the image may be added to an existing cluster. If the image cannot be added to the existing cluster (e.g., image contains body features that are not similar to existing clusters), the process may perform a metadata check.

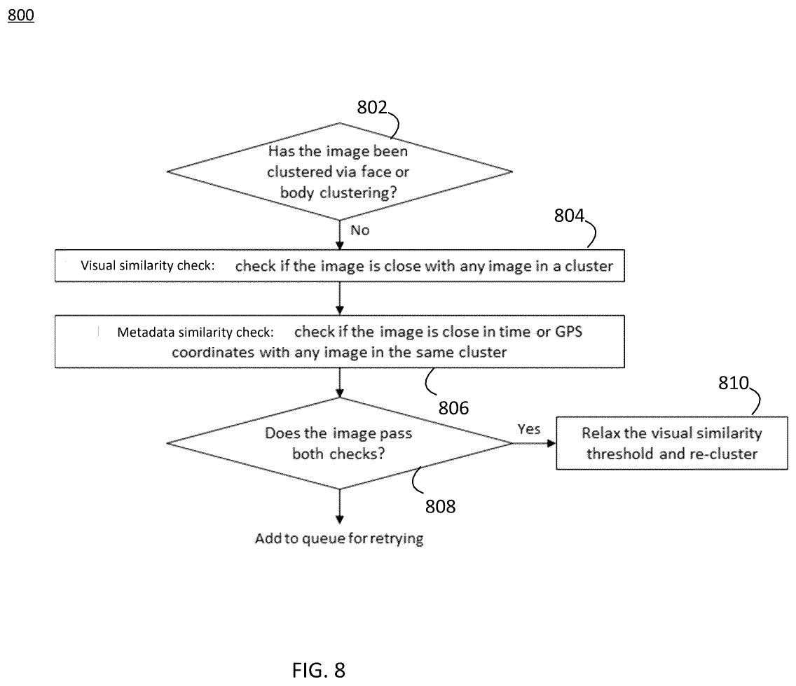

In one or more examples, to integrate metadata, the visual similarity thresholds used in both face and body clustering stages may be relaxed if the images may be associated with a cluster through timestamp and GPS information. FIG. 8 illustrates a process 800 for determining when to relax a visual similarity threshold. The process may start at operation 802, where it is determined that an image has not been clustered via face or body clustering. The process proceeds to operation 804 where a visual similarity check is performed. For face clustering with metadata, it may be checked whether the new image is within a tight distance threshold with at least one photo in the face cluster (e.g., visual similarity check). In one or more examples, the distance threshold is associated with a face embedding similarity.

The process proceeds to operation 806 where a metadata similarity check is performed. For example, there may exist a photo in the cluster that is close in time or close in GPS coordinates (e.g., metadata similarity check). In one or more examples, if an image meets both checks (808), the visual similarity threshold with the cluster centroid may be relaxed, and based on the relaxed visual similarity threshold, it may be determined to add the image to the cluster. In one or more examples, for body clustering with metadata, the same method illustrated in FIG. 8 may be used, but with body embeddings and body centroids of the face clusters.

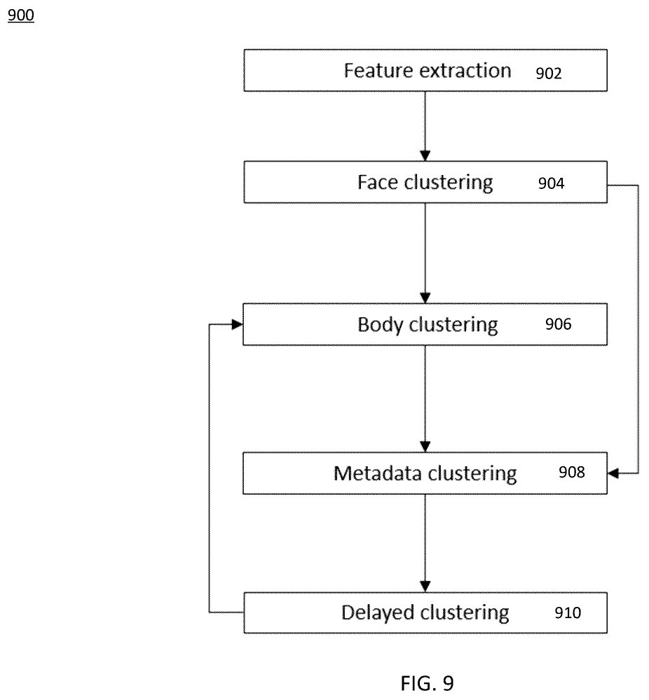

FIG. 9 illustrates a block diagram 900 of the clustering system in accordance with one or more embodiments. The clustering system may include a feature extraction block 902, a face clustering block 904, a body clustering block 906, a metadata clustering block 908, and a delayed clustering block 910.

In one or more examples, the feature extraction block 902 may receive as input one or more new images to be clustered, and may output face and body embeddings of pets (if present).

In one or more examples, the face clustering block 904 may receive as input one of more face embeddings of pets and may output cluster assignment of pets (e.g., either added to existing clusters or left as a singleton cluster).

In one or more examples, the body clustering block 906 may receive as input one or more body embeddings of pets or one or more existing face clusters, and may output cluster assignment of the pets (e.g., either added to existing clusters or left as unclustered).

In one or more examples, the metadata clustering block 908 may receive one or more face/body embeddings of unclustered pets or singleton clusters and may output cluster assignment of the pets (e.g., for face: either added to existing clusters or left as a singleton cluster; for body: either added to existing clusters or left as unclustered).

In one or more examples, the delayed clustering block 910 may receive as input one or more body embeddings of unclustered pets and singleton clusters and may output a queue with the embeddings of the unclustered pets and singleton clusters from a current round added to the queue.

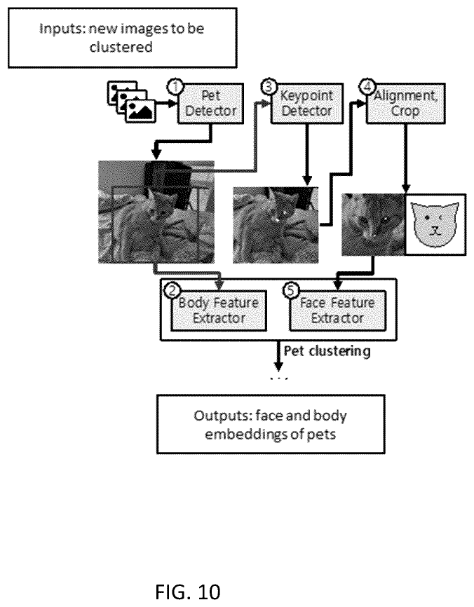

FIG. 10 illustrates an example pet detection and feature extraction system. The extraction system illustrated in FIG. 10 may be part of the feature extraction block 902.

Prior to clustering, any pets in the images need to be located. Then, the appropriate face and body embeddings are extracted. Initially, given a set of images, a pet detector is used to identify images containing pets. If a pet is present, body embeddings are extracted for the pet crop.

Next, a face keypoint detector is employed to pinpoint three critical points on each pet face (e.g., left eye, right eye, and muzzle). These keypoints serve two purposes: first, they help determine whether the image has a proper visible face (e.g., face-visible images); second, they enable alignment of face-visible images to exploit geometric regularities of the facial appearances. Several heuristics may be employed to verify the validity of the keypoints, including checking whether the points are sufficiently spread out (e.g., model does not return the same keypoint) and checking whether the distances between the keypoints are similar (i.e., the triangle formed by the keypoints are close to an equilateral triangle).

To perform face alignment, a linear transformation between the predicted keypoints and a canonical set of points may be estimated via a similarity transform. The transformation may be applied to obtain an aligned face image, which is passed into a face embedding model for feature extraction.

As illustrated in FIG. 10, given an image, the location of pets may be detected (1), and the regions may be cropped accordingly. The cropped images may be passed into a body feature extractor (2) to obtain body embeddings, and a keypoint detector (3) to obtain face keypoints (e.g., left eye, right eye, muzzle). If the detected keypoints pass a set of pre-defined heuristics, the image may be determined to have a face-visible pet. The keypoints may then be aligned (4) to a canonical set of keypoints through a similarity transform. Furthermore, face embeddings may be extracted (5) from the aligned face image.

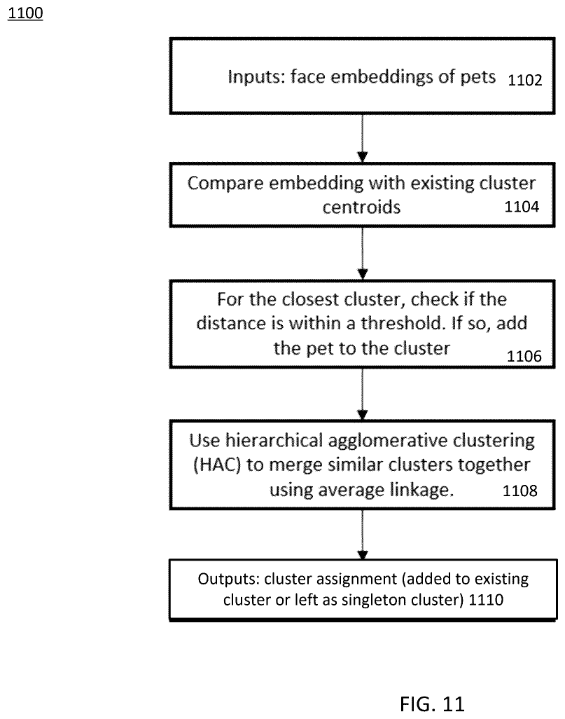

FIG. 11 illustrates an example face clustering process 1100. The face clustering process 1100 may be implemented by the face clustering block 904. The face clustering process may receive as input one or more face embeddings of pets 1102. The process proceeds to operation 1104 to compare the embeddings with existing cluster centroids. The process proceeds to 1106 to check if the distance for the closest cluster is within a threshold, and if so, add the image of a pet to the cluster. The process proceeds to 1108 to use hierarchical agglomerative clustering (HAC) to merge similar clusters together using an average linkage. The process proceeds to operation 1110 to output a cluster assignment (e.g., added to existing cluster or left as a singleton cluster).

In one or more examples, to form the initial set of face clusters, a clustering algorithm such as C-Clustering may be used. C-Clustering is efficient and effective in grouping similar faces together. In one or more examples, the algorithm maintains only a centroid embedding for each cluster, computed as the mean of all face embeddings within that cluster. When a new image is added, its face embedding, e_{f}, is compared to the centroids, Cᵢ(iε[1 . . . m]) of m existing clusters. The image may be assigned to the closet cluster if the distance is below a pre-defined threshold, face_thresh. If the distance to the closest cluster is not below the pre-defined threshold, a new cluster is created as illustrated in Eq. (1) and FIG. 4.

$${cluster}_{i d} = \{ \begin{matrix}arg {min}_{i} dist ( {e}_{f} , {C}_{i} ) , & if {min}_{i} dist ( {e}_{f} , {C}_{i} ) < face\_thresh \\ m + 1 , & otherwise .\end{matrix} \qquad Eq . ( 1 )$$

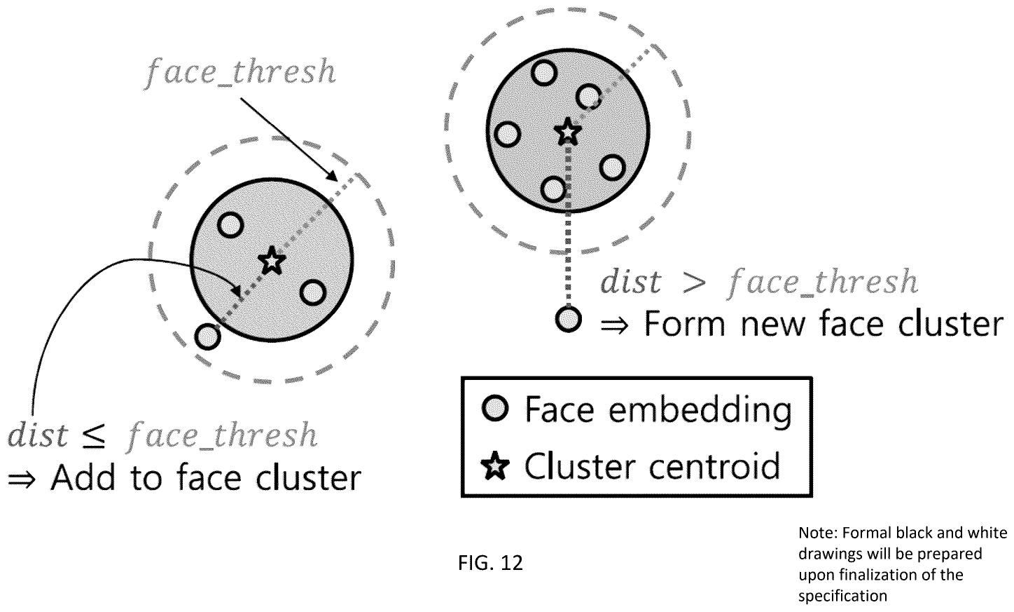

FIG. 12 illustrates two operations in C-Clustering. When a new image arrives, a face embedding of the image may be computed and compared with the centroid embeddings of existing clusters. If the distance between the new image and any existing cluster is within a predetermined threshold (face_thresh), the image may be assigned to the cluster that has the smallest distance (e.g., the closest match). Otherwise, a new cluster is created and this image may be added to the new cluster.

During C-Clustering, if a new image is not similar enough to existing clusters, a new cluster may be created. While this strategy maintains high precision, this strategy may lead to over-clustering, where multiple clusters are formed for the same pet.

To alleviate over-clustering, a hierarchical agglomerative clustering (HAC) algorithm (see FIG. 5) may be used to merge together clusters that likely refer to the same identity together. In one or more examples, HAC is a greedy method that iteratively merges the two closest clusters until a maximum distance threshold, hac_thresh, is reached. In one or more examples, only clusters containing at least two images are considered for merging (not the singleton clusters). To enhance the scalability and clustering performance of the embodiments, two key modifications are made to the HAC algorithm. First, to ensure scalability independent of the growing gallery size, randomly chosen representative prototypes from each cluster are used instead of using all data points when calculating pairwise distances between clusters. Second, when merging two clusters, rather than combining them into a single new cluster, they are left as two separate clusters, but assigned a unified identity label to preserve information in the individual clusters.

According to one or more embodiments, images that do not contain visible faces may be clustered, which advantageously improves recall. To cluster body-only images, an approach that bootstraps from existing face clusters may be used.

As shown in FIG. 5 (Body Classifier), the initial set of face clusters is leveraged to create a training set for the body classifier, in which the input data is the body features of images in the face cluster (body_features), and the class label is the corresponding cluster label (pet_id). The classifier may then be used to predict the cluster label for the body-only images, thereby maintaining high precision while boosting recall. Sparse coding is adopted as the body classifier for its superior performance in evaluation, though simpler and more common algorithms (e.g., k−Nearest Neighbor) could also be applied.

In one or more examples, sparse coding may be formulated as in the following equation.

$${min}_{x} {‖ {e}_{b} - D * x ‖}_{2}^{2} + λ {‖ x ‖}_{1} , \qquad Eq . ( 2 )$$

where D is the dictionary containing all the body embeddings in existing clusters and e_{b} is the new body embedding. By solving this optimization problem, a sparse code, x, is determined such that e_{b}≈D·x, with X controlling the code sparsity under the Li norm. The image associated with e_{b} will be assigned to the cluster with the highest accumulated weight in the code x that meets a pre-defined threshold.

In one or more examples, since C-Clustering is a centroid-based approach, face photos captured under extreme conditions may be too dissimilar from the majority of the photos of the same identity and end up forming their own distinct clusters. These images may be referred to as singleton clusters since they are each “clusters of 1”. Using body features of the singleton clusters may be adopted to link them to existing face clusters. This step maintains the advantageous high precision characteristics of C-Clustering, while greatly reducing over-clustering.

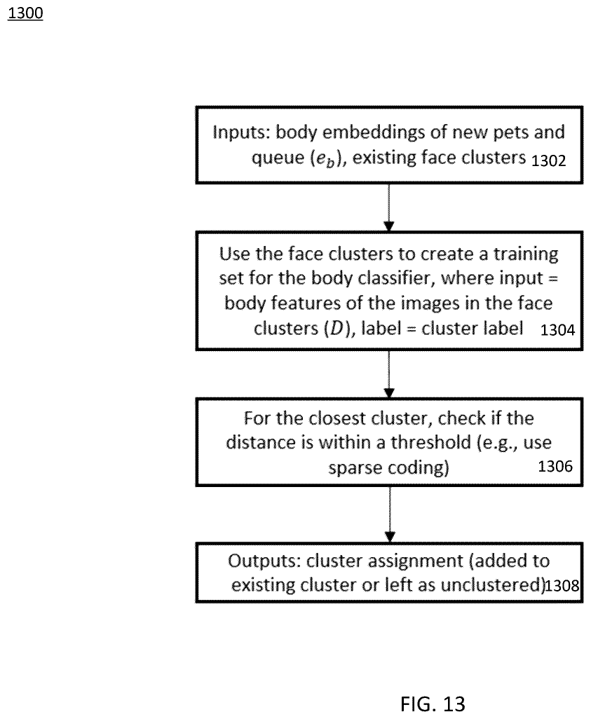

FIG. 13 illustrates a flowchart of an example body clustering process 1300. The body clustering process 1300 may be implemented by the body clustering block 906. The body clustering process may receive as input one or more body embeddings of new pets, a queue (e_{b}), and/or existing face clusters 1302. The process proceeds to operation 1304 to use the face clusters to create a training set for the body classifier, where input equals body features of the images in the face clusters (D) and label equals cluster label. The process proceeds to operation 1306 to check if a distance for the closest cluster is within a threshold (e.g., use sparse coding), and if so, add an image of a pet to the cluster. The process proceeds to operation 1308 to output a cluster assignment (e.g., added to existing cluster or left as unclustered).

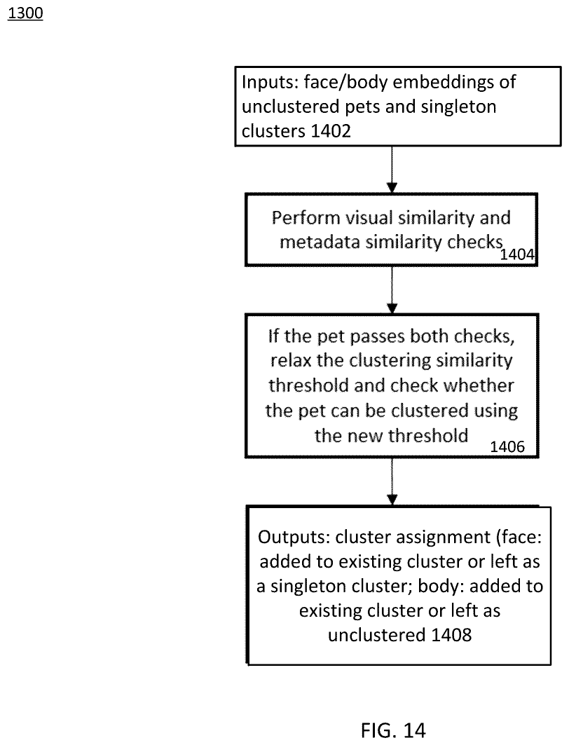

FIG. 14 illustrates a flowchart of an example metadata clustering process 1400. The metadata clustering process 1400 may be performed by the metadata clustering block 908. The metadata clustering process may receive as input face/body embeddings of unclustered pets or singleton clusters 1402. The process proceeds to operation 1404 to perform a visual similarity and metadata similarity checks. The process proceeds to operation 1406, where if an image of a pet passes both checks, the clustering similarity threshold may be relaxed, and whether the image of the pet can be clustered using the relaxed threshold is checked. The process proceeds to operation 1408 to output a cluster assignment (e.g., face: added to existing cluster or left as a singleton cluster; body: added to existing cluster or left as unclustered).

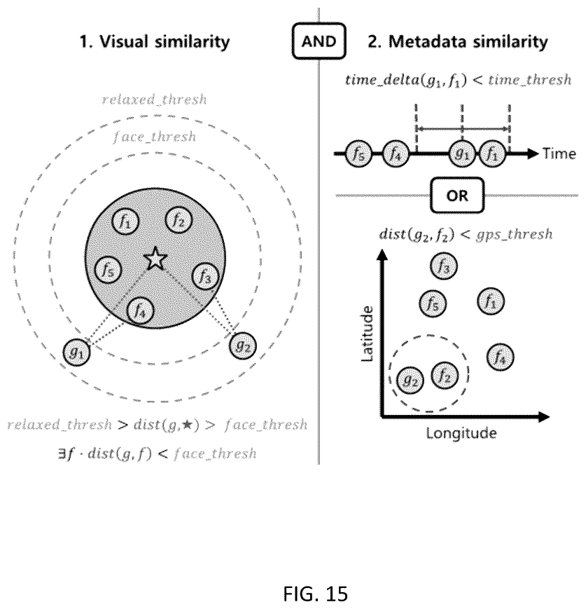

In one or more examples, to integrate metadata, visual similarity thresholds used in various clustering stages may be relaxed if images may be related through timestamp and GPS information. Example visual similarity and metadata similarity conditions for adding candidate face photos to existing face clusters during C-Clustering are illustrated in FIG. 15. In one or more examples, these conditions may also be applied to the body classifier when purely visual features are insufficient to add a body-only image to an existing cluster.

FIG. 15 illustrates example visual similarity and metadata similarity data conditions with C-Clustering. In one or more examples, the distance threshold may be relaxed from face_thresh to relaxed_thresh when processing new points (e.g., g₁) if two conditions are met: visual similarity and metadata similarity. The visual similarity check verifies that at least one image in the existing cluster is within face_thresh of the new points, while the metadata similarity check ensures that at least one image is within the time window (e.g., time_thresh) or GPS window (e.g., gps_thresh) of the new image.

The original C-Clustering algorithm may be designed to maintain high precision and therefore, uses a tight distance threshold face_thresh for adding a new face photo to an existing face cluster. However, when it does not meet the distance requirement, the face_thresh may be relaxed to relaxed_thresh if it meets two checks, visual similarity check and metadata similarity check. For the visual similarity check, the new image must be within the tight distance threshold face_thresh of at least one photo in the cluster. While for the metadata similarity check, there should exist a photo in an existing cluster that is close in time or close in GPS coordinates with the new image.

In one or more examples, if a body feature is too visually dissimilar to be mapped to existing face clusters, the same metadata-enhanced C-Clustering algorithm is enhanced to body features using body centroids and body embeddings of the corresponding face clusters. For example, for each body-only image, it is determined whether the image meets the visual similarity and that metadata similarity checks with existing face clusters using body information. If both the visual similarity and metadata similarity checks are satisfied, the distance requirement may be relaxed, and subsequently, it may be determined whether the image's body embedding is within relaxed_thresh of the cluster's body centroid.

In one or more examples, images may be clustered according to batch processing. However, in some examples, batch processing may assume statically sized datasets that do not hold in real-world scenarios where images are added incrementally to a gallery. In one or more examples, to maintain the high recall of batch clustering, photos that do not yet have enough similar photos to form clusters are delayed from clustering. Moreover, the incremental clustering pipeline may handle continuously growing galleries by scaling independently of the gallery size.

A key challenge in the incremental setting is that on any given day, there may not be enough photos yet to form an initial cluster, which could lead to poor recall on days with a sparse number of photos taken. However, it is common to see additional photos arrive in subsequent days for the owner's pet(s), which makes delayed clustering possible for the proposed clustering method. In delayed clustering (see FIG. 5, Delayed Decision), images that failed to be clustered previously (e.g., singleton clusters or dissimilar body-only images) may be preserved in a queue and re-routed through the body classifier in subsequent clustering runs. This approach improves recall and adds very little additional computational cost that can be controlled by limiting queue growth within a reasonable time window.

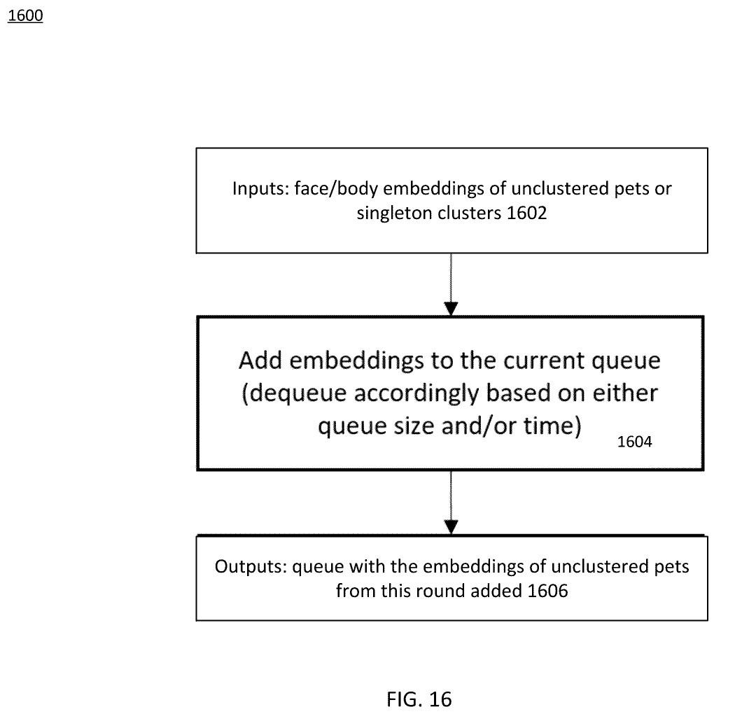

FIG. 16 illustrates a flowchart of an example delayed clustering process 1600. The delayed clustering process 1600 may be implemented by the delayed clustering block 910. The delayed clustering process 1600 may receive as inputs face/body embeddings of unclustered pets or singleton clusters. The process proceeds to operation 1604 to add the embeddings to a current queue. Items from the queue may be removed based on either queue size and/or time. The process proceeds to operation 1606 to output the queue with the embeddings of unclustered pets or singleton clusters from a current round added to the queue.

The embodiments of the present disclosure implements an incremental clustering pipeline that handles continuously growing galleries, and scales independently of the gallery size, which is a requirement for enabling practical on-device deployments. Incremental scaling may be achieved through optimal processing at each stage of the clustering pipeline. With face C-Clustering, each new face embedding may be compared against O([#Pets]) face centroids. With HAC cluster merging, there are O([#Pets]) face clusters each with O(1) prototype samples, and in the worst case, all pairwise distances are computed between those clusters, resulting in O([#Pets]²) runtime. With the body classifier, the number of classifier labels is O([#Pets]) and the training samples per label is O(1) prototype samples.

Together, these optimizations ensure incrementally clustering [#Photos Added] per day scales independent of the continuously growing gallery size.

$$O ( {[ \#Pets ]}^{2} * [ \#Photos Added ] ) . \qquad Eq . ( 3 )$$

The above disclosure also encompasses the embodiments listed below:

(1) A method performed by at least one processor includes: receiving a plurality of images; detecting an object in at least one image from the plurality of images; performing feature extraction on the object to extract a first feature of the object and extract a second feature of the object; selecting an image from the plurality of images; based on determining the selected image includes the first feature, adding the selected image to a cluster associated with the object; and based on determining the selected image does not include the first feature and includes the second feature, adding the selected image to the cluster associated with the object based on determining the second features satisfies a feature distance condition.

(2) The method according to feature (1), further including: based on determining the second feature does not satisfy the feature distance condition, determining whether the selected image satisfies a visual similarity condition and a metadata condition; based on determining the selected images satisfies the visual similarity condition and the metadata condition, reducing a visual similarity threshold associated with the cluster; and determining whether to add the selected image to the cluster based on the reduced similarity threshold.

(3) The method according to feature (2), in which the visual similarity threshold is associated with one of the first feature or the second feature.

(4) The method according to feature (2), in which the visual similarity condition specifies that a third feature has a similarity score greater than the visual similarity threshold.

(5) The method according to feature (2), in which the metadata condition specifies that the selected image is taken within a predetermined amount of a time that another image added to the cluster was taken.

(6) The method according to feature (2), in which the metadata condition specifies that the selected image is taken at a location that is within a predetermined distance of location that another image added to the cluster was taken.

(7) The method according to feature (2), the method further including: based on determining that the selected image is not added to the cluster based on the reduced similarity threshold, storing the selected image in a queue; and determining, after a predetermined amount of time, whether to add each image included in the queue to the cluster.

(8) The method according to any one of features (1)-(7), in which the object is an animal.

(9) The method according to feature (8), in which the first feature is a face of the animal.

(10) The method according to feature (8) or (9), in which the second feature is a body of the animal.

(11) An apparatus includes a memory; processing circuitry coupled to the memory, the processing circuitry configured to: receive a plurality of images, detect an object in at least one image from the plurality of images, perform feature extraction on the object to extract a first feature of the object and extract a second feature of the object, select an image from the plurality of images, based on determining the selected image includes the first feature, add the selected image to a cluster associated with the object, and based on determining the selected image does not include the first feature and includes the second feature, add the selected image to the cluster associated with the object based on determining the second feature satisfies a feature distance condition.

(12) The apparatus according to feature (11), in which the processing circuitry is further configured to: based on determining the second feature does not satisfy the feature distance condition, determine whether the selected image satisfies a visual similarity condition and a metadata condition, based on determining the selected images satisfies the visual similarity condition and the metadata condition, reduce a visual similarity threshold associated with the cluster, and determine whether to add the selected image to the cluster based on the reduced similarity threshold.

(13) The apparatus according to feature (12), in which the visual similarity threshold is associated with one of the first feature or the second feature.

(14) The apparatus according to feature (12), in which the visual similarity condition specifies that a third feature has a similarity score greater than the visual similarity threshold.

(15) The apparatus according to feature (12), in which the metadata condition specifies that the selected image is taken within a predetermined amount of a time that another image added to the cluster was taken.

(16) The apparatus according to feature (12), in which the metadata condition specifies that the selected image is taken at a location that is within a predetermined distance of location that another image added to the cluster was taken.

(17) The apparatus according to feature (12), in which the processing circuitry is further configured to: based on determining that the selected image is not added to the cluster based on the reduced similarity threshold, store the selected image in a queue, and determine, after a predetermined amount of time, whether to add each image included in the queue to the cluster.

(18) The apparatus according to any one of features (11)-(17), in which the object is an animal.

(19) The apparatus according to feature (18), in which the first feature is a face of the animal.

(20) A non-transitory computer readable medium having in instructions stored therein, which when executed by a processor cause the processor to execute a method including: receiving a plurality of images; detecting an object in at least one image from the plurality of images; performing feature extraction on the object to extract a first feature of the object and extract a second feature of the object; selecting an image from the plurality of images; based on determining the selected image includes the first feature, adding the selected image to a cluster associated with the object; and based on determining the selected image does not include the first feature and includes the second feature, adding the selected image to the cluster associated with the object.

What is claimed is:

1. A method performed by at least one processor, the method comprising:
receiving a plurality of images;
detecting an object in at least one image from the plurality of images;
performing feature extraction on the object to extract a first feature of the object and extract a second feature of the object;
selecting an image from the plurality of images;
based on determining the selected image includes the first feature, adding the selected image to a cluster associated with the object; and
based on determining the selected image does not include the first feature and includes the second feature, adding the selected image to the cluster associated with the object based on determining the second feature satisfies a feature distance condition.

2. The method according to claim 1, further comprising:
based on determining the second feature does not satisfy the feature distance condition, determining whether the selected image satisfies a visual similarity condition and a metadata condition;
based on determining the selected images satisfies the visual similarity condition and the metadata condition, reducing a visual similarity threshold associated with the cluster; and
determining whether to add the selected image to the cluster based on the reduced similarity threshold.

3. The method according to claim 2, wherein the visual similarity threshold is associated with one of the first feature or the second feature.

4. The method according to claim 2, wherein the visual similarity condition specifies that a third feature has a similarity score greater than the visual similarity threshold.

5. The method according to claim 2, wherein the metadata condition specifies that the selected image is taken within a predetermined amount of a time that another image added to the cluster was taken.

6. The method according to claim 2, wherein the metadata condition specifies that the selected image is taken at a location that is within a predetermined distance of location that another image added to the cluster was taken.

7. The method according to claim 2, the method further comprising:
based on determining that the selected image is not added to the cluster based on the reduced similarity threshold, storing the selected image in a queue; and
determining, after a predetermined amount of time, whether to add each image included in the queue to the cluster.

8. The method according to claim 1, wherein the object is an animal.

9. The method according to claim 8, wherein the first feature is a face of the animal.

10. The method according to claim 8, wherein the second feature is a body of the animal.

11. An apparatus comprising:
a memory;
processing circuitry coupled to the memory, the processing circuitry configured to:
receive a plurality of images,
detect an object in at least one image from the plurality of images,
perform feature extraction on the object to extract a first feature of the object and extract a second feature of the object,
select an image from the plurality of images,
based on determining the selected image includes the first feature, add the selected image to a cluster associated with the object, and
based on determining the selected image does not include the first feature and includes the second feature, add the selected image to the cluster associated with the object based on determining the second feature satisfies a feature distance condition.

12. The apparatus according to claim 11, wherein the processing circuitry is further configured to:
based on determining the second feature does not satisfy the feature distance condition, determine whether the selected image satisfies a visual similarity condition and a metadata condition,
based on determining the selected images satisfies the visual similarity condition and the metadata condition, reduce a visual similarity threshold associated with the cluster, and
determine whether to add the selected image to the cluster based on the reduced similarity threshold.

13. The apparatus according to claim 12, wherein the visual similarity threshold is associated with one of the first feature or the second feature.

14. The apparatus according to claim 12, wherein the visual similarity condition specifies that a third feature has a similarity score greater than the visual similarity threshold.

15. The apparatus according to claim 12, wherein the metadata condition specifies that the selected image is taken within a predetermined amount of a time that another image added to the cluster was taken.

16. The apparatus according to claim 12, wherein the metadata condition specifies that the selected image is taken at a location that is within a predetermined distance of location that another image added to the cluster was taken.

17. The apparatus according to claim 12, wherein the processing circuitry is further configured to:
based on determining that the selected image is not added to the cluster based on the reduced similarity threshold, store the selected image in a queue, and
determine, after a predetermined amount of time, whether to add each image included in the queue to the cluster.

18. The apparatus according to claim 11, wherein the object is an animal.

19. The apparatus according to claim 18, wherein the first feature is a face of the animal.

20. A non-transitory computer readable medium having in instructions stored therein, which when executed by a processor cause the processor to execute a method comprising:
receiving a plurality of images;
detecting an object in at least one image from the plurality of images;
performing feature extraction on the object to extract a first feature of the object and extract a second feature of the object;
selecting an image from the plurality of images;
based on determining the selected image includes the first feature, adding the selected image to a cluster associated with the object; and
based on determining the selected image does not include the first feature and includes the second feature, adding the selected image to the cluster associated with the object based on determining the second features satisfies a feature distance condition.
